(19) United States
(12) Patent Application Publication
(10) Pub. No.: US 2024/0108177 A1
(43) Pub. Date: Apr. 4, 2024

(54) MATERIAL CLEANING METHOD, COOKING APPLIANCE, AND READABLE STORAGE MEDIUM

(71) Applicant: FOSHAN SHUNDE MIDEA ELECTRICAL HEATING APPLIANCES MANUFACTURING CO., LTD., Foshan (CN)

(72) Inventors: Yuquan WU, Foshan (CN); Baomin YANG, Foshan (CN); Tianshui WANG, Foshan (CN); Houchao FU, Foshan (CN); Jiakong LI, Foshan (CN); Liangliu WU, Foshan (CN)

(21) Appl. No.: 18/270,315

(22) PCT Filed: Dec. 24, 2021
(86) PCT No.: PCT/CN2021/141299

§ 371 Date: Jun. 29, 2023

(30) Foreign Application Priority Data
Dec. 29, 2020 (CN) 202011610723.5
Dec. 29, 2020 (CN) 202011611508.7

(51) Int. Cl. A47J 43/24; A47J 36/00; A47J 44/00

(52) U.S. Cl. CPC A47J 43/24; A47J 36/00; A47J 44/00

(57) ABSTRACT

A material cleaning method includes controlling a transportation device of a cooking appliance to move in an accommodation cavity of the cooking appliance, to make a transportation port of the transportation device move in material in the accommodation cavity, and controlling the transportation device to blow air through the transportation port to clean the material in the accommodation cavity.

### CROSS-REFERENCE TO RELATED APPLICATIONS

The present application claims priority to Chinese Patent Application Nos. 202011611508.7 and 202011610723.5, both filed on Dec. 29, 2020, the entire contents of which are incorporated herein by reference.

### TECHNICAL FIELD

The present application relates to the field of household electric appliances, and in particular to a material cleaning method, a cooking appliance, and a readable storage medium.

### BACKGROUND

In order to meet people's need, smart rice cooker is produced. A smart rice cooker can realize functions such as automatically supplying water and washing rice and cooking rice to bring a lot of convenience to people's life.

In the related art, a smart rice cooker can only spray water into the inner pot at a fixed position during rice washing, and then drain the liquid out after mixing the rice and water, which brings a poor cleaning effect.

### SUMMARY

The main purpose of the present application is to provide a material cleaning method, aiming to improve the automatic cleaning effect of the material.

To achieve the above purpose, the present application provides a material cleaning method, applied to a cooking appliance, the cooking appliance includes an accommodation cavity and a transportation device with a transportation port, the method includes:
controlling the transportation device to move in the accommodation cavity, to make the transportation port move in material in the accommodation cavity, and controlling the transportation device to blow air through the transportation port to clean the material in the accommodation cavity.

In the technical solution of the present application, during the material cleaning, after inputting the material into the accommodation cavity, the transportation device is controlled, so that the transportation port extends into the material for blowing the air, the material is driven by the airflow to fully tumble and mix, and the material cleaning method of the present application also controls the transportation port to move in the material during blowing the air, so that the transportation port will not be in a fixed position to blow the air, the location of the transportation port will constantly be changed, so that the material is stirred and tumbled more violently, so that the material in the accommodation cavity can be fully stirred, thereby enhancing the cleaning effect.

In an embodiment, the material includes a grain and a liquid to soak the grain, in the controlling the transportation device to move in the accommodation cavity, to make the transportation port move in the material in the accommodation cavity, and controlling the transportation device to blow the air through the transportation port to clean the material in the accommodation cavity, the transportation port moves up and down in the liquid above the grain.

In an embodiment, the material includes a grain and a liquid to soak the grain, in the controlling the transportation device to move in the accommodation cavity, to make the transportation port move in the material in the accommodation cavity, and controlling the transportation device to blow the air through the transportation port to clean the material in the accommodation cavity, the transportation port moves up and down in the grain.

In an embodiment, the cooking appliance further includes a material supply device, before the controlling the transportation device to move in the accommodation cavity, to make the transportation port move in the material in the accommodation cavity, and controlling the transportation device to blow the air through the transportation port to clean the material in the accommodation cavity, the method further includes:
controlling the material supply device to input the grain to the accommodation cavity; and
controlling the transportation device to inject the liquid into the accommodation cavity to soak the grain.

In an embodiment, the transportation device includes a telescopic assembly and a transportation pipe connected to the telescopic assembly, the transportation pipe is provided with the transportation port, the controlling the transportation device to move in the accommodation cavity, to make the transportation port move in the material in the accommodation cavity, and controlling the transportation device to blow the air through the transportation port to clean the material in the accommodation cavity includes:
obtaining an amount of the input grain;
matching a preset telescopic distance of the telescopic assembly according to the amount of the grain;
controlling the telescopic assembly to drive the transportation port to move up and down in the grain based on a matched preset telescopic distance, and controlling the transportation pipe to blow the air to clean the grain in the accommodation cavity; or
obtaining the amount of the grain that is input;
calculating a height of the grain in the accommodation cavity based on the amount of the grain and a volume parameter of the accommodation cavity;
calculating a telescopic distance of the telescopic assembly based on the height; and
controlling the telescopic assembly to drive the transportation port to move up and down in the grain based on the telescopic distance, and controlling the transportation pipe to blow the air to clean the grain in the accommodation cavity.

In an embodiment, the telescopic assembly includes a plurality of sleeves sealed and nested with each other, and a reset member connected between two adjacent sleeves.

The cooking appliance further includes a drive assembly in communication with the sleeves and configured for filling the sleeves with a drive medium to make the plurality of the sleeves to telescope, the controlling the telescopic assembly to drive the transportation port to move up and down in the grain based on the telescopic distance, and controlling the transportation pipe to blow the air to clean the grain in the accommodation cavity includes:
determining a pressure range of a required drive medium when the sleeves telescope based on the telescopic distance and an elastic force parameter of the reset member; and
controlling the drive assembly based on the pressure range to inject the drive medium into the sleeves, to make the plurality of the sleeves to telescope within the telescopic distance, to drive the transportation port to move up and down in the grain, and controlling the transportation pipe to blow the air to clean the grain in the accommodation cavity.

In an embodiment, the controlling the transportation pipe to blow the air to clean the grain in the accommodation cavity includes:
obtaining an amount of the grain that is input;
matching a preset air-blowing frequency of the transportation device according to the amount of the grain; and
controlling the transportation device to blow the air based on a matched air-blowing frequency; or
obtaining an amount of the material input;
calculating an air-blowing frequency of the transportation device based on the amount of material and a volume parameter of the accommodation cavity; and
controlling the transportation device to blow the air according to the calculated air-blowing frequency.

In an embodiment, after the controlling the transportation device to blow the air through the transportation port, the method further includes:
controlling the transportation device to stop after blowing the air for a preset time;
controlling the transportation device to drive the transportation port to move to a bottom of the grain; and
controlling the transportation device to suck up through the transportation port to drain the liquid out of the accommodation cavity.

The present application also provides a material cleaning method, applied to a cooking appliance. The cooking appliance includes an accommodation cavity, a transportation device in communication with the accommodation cavity, the transportation device is provided with a transportation port, the material cleaning method includes:
obtaining an amount of material in the accommodation cavity; and
controlling the transportation device to telescope based on the amount of the material, to make the transportation port extend into a preset position in the accommodation cavity, and to transport through the transportation port.

In an embodiment, the material includes a grain and a liquid to soak the grain, the controlling the transportation device to telescope based on the amount of the material, to make the transportation port extend into the preset position in the accommodation cavity, and to transport through the transportation port includes:
controlling the transportation device to telescope based on the amount of the grain, to make the transportation port extend into the liquid above the grain, and to transport air into the accommodation cavity through the transportation port.

In an embodiment, the material includes grain and a liquid to soak the grain, the controlling the transportation device to telescope based on the amount of the material, to make the transportation port extend into the preset position in the accommodation cavity, and to transport through the transportation port includes:
controlling the transportation device to telescope based on the amount of the grain, to make the transportation port extend into the grain in the accommodation cavity, and to transport air into the accommodation cavity through the transportation port.

In an embodiment, in the controlling the transportation device to telescope based on the amount of the grain, to make the transportation port extend into the grain in the accommodation cavity, the transportation port extends to a middle position of a height of the grain.

In an embodiment, the transportation device includes a telescopic assembly and a transportation pipe provided in the telescopic assembly, the transportation pipe is provided with the transportation port, the controlling the transportation device to telescope based on the amount of the material, to make the transportation port extend into the preset position in the accommodation cavity includes:
matching a preset telescopic distance of the telescopic assembly according to the amount of the material;
controlling the telescopic assembly to telescope based on a matched preset telescopic distance, to make the transportation port extend into the preset position in the accommodation cavity; or
calculating a telescopic distance of the telescopic assembly based on the amount of the material and a volume parameter of the accommodation cavity; and
controlling the telescopic assembly to telescope based on the telescopic distance, to make the transportation port extend into the preset position in the accommodation cavity.

In an embodiment, the cooking appliance further includes a drive device, the telescopic assembly includes a plurality of sleeves sealed and nested with each other and a reset member connected between two adjacent sleeves, the drive device is configured for injecting a drive medium into the sleeves;
the controlling the telescopic assembly to telescope based on a matched preset telescopic distance, to make the transportation port extend into the preset position in the accommodation cavity includes:
determining a pressure of the drive medium required to drive the sleeves to extend out based on a correspondence relationship of the matched preset telescopic distance and an elastic force parameter of the reset member; and
controlling the drive device to inject the drive medium of the pressure into the sleeves, to make the plurality of the sleeves to telescope, to make the transportation port extend into the preset position in the accommodation cavity; or
the controlling the telescopic assembly to telescope based on the telescopic distance, to make the transportation port extend into the preset position in the accommodation cavity includes:
calculating the pressure of the drive medium required to drive the sleeves to extend out based on the telescopic distance and the elastic force parameter of the reset member; and
controlling the drive device to inject the drive medium of the pressure into the sleeves, to make the plurality of the sleeves to telescope, to make the transportation port extend into the preset position in the accommodation cavity.

In an embodiment, after the controlling the transportation device to telescope based on the amount of the grain, to make the transportation port extend into the grain in the accommodation cavity, and to transport the air into the accommodation cavity through the transportation port, the method further includes:
controlling the transportation device to telescope, to make the transportation port extend into a bottom of the grain, and to drain the liquid out from the accommodation cavity through the transportation port.

In an embodiment, after the controlling the transportation device to telescope, to make the transportation port extend into the bottom of the grain, and to drain the liquid out from the accommodation cavity through the transportation port, the method further includes:
controlling the transportation device to telescope, to make the transportation port exit the grain;
controlling the transportation device to inject a preset amount of the liquid into the accommodation cavity based on the amount of the grain; and
controlling the transportation device to telescope, to make the transportation port extend into the liquid above the grain for cleaning.

The present application also provides a cooking appliance, including a controller, an accommodation cavity and a transportation device in communication with the accommodation cavity. The transportation device is provided with a transportation port, the controller is configured to implement the material cleaning method according to any one of embodiments as mentioned above.

The present application also provides a readable storage medium, a control program of a cooking appliance is stored on the readable storage medium, the control program of the cooking appliance when executed by a processor implements the material cleaning method according to any one of embodiments as mentioned above.

### BRIEF DESCRIPTION OF THE DRAWINGS

FIG. 1 is a schematic flowchart of a material cleaning method according to an embodiment of the present application.

FIG. 2 is a sectional view of a cooking appliance according to an embodiment of the present application.

FIG. 3 is an enlarged view at position A in FIG. 2.

FIG. 4 is a schematic flowchart of a material cleaning method according to another embodiment of the present application.

FIG. 5 is a refined schematic flowchart of S30 in FIG. 4 according to an embodiment of the present application.

FIG. 6 is a refined schematic flowchart of S30 in FIG. 4 according to another embodiment of the present application.

FIG. 7 is a refined schematic flowchart of S33 in FIG. 5 according to an embodiment of the present application.

FIG. 8 is a schematic flowchart of a material cleaning method according to another embodiment of the present application.

FIG. 9 is a schematic flowchart of a material cleaning method according to an embodiment of the present application.

FIG. 10 is a schematic flowchart of a material cleaning method according to an embodiment of the present application.

FIG. 11 is a schematic flowchart of a material cleaning method according to an embodiment of the present application.

FIG. 12 is a schematic flowchart of a material cleaning method according to an embodiment of the present application.

FIG. 13 is a schematic flowchart of a material cleaning method according to an embodiment of the present application.

FIG. 14 is a schematic structural diagram of a device of a hardware operation environment involved in an embodiment of the present application.

### DESCRIPTION OF THE REFERENCE SIGNS

| Reference sign | Name |
|---|---|
| 10 | cooking appliance |
| 20 | pot body |
| 30 | pot lid |
| 31 | accommodation cavity |
| 40 | water pump |
| 50 | air pump |
| 60 | pipe |
| 61 | transportation port |
| 70 | material supply device |
| 71 | material storage |
| 72 | control valve |
| 80 | telescopic assembly |
| 81a, 81b, 81c, 81d | sleeve |
| 82 | seal ring |
| 83 | reset member |

The realization of the purpose of this application, functional features and advantages will be combined with embodiments, with reference to the drawings for further explanation.

### DETAILED DESCRIPTION OF THE EMBODIMENTS

It should be understood that the specific embodiments described herein are intended only to explain the present application and are not intended to limit the present application.

Since in the related art, usually, during the automatic cooking of a traditional cooking appliance 10 with automatic cooking function, such as an electric rice cooker with automatic rice cooking function, after inputting the rice into the inner pot, only water will be injected into the inner pot from a fixed position in the cleaning operation, and after the rice and water are mixed, then the water after cleaning will be drained to the outside. However, in the traditional cooking process, when washing rice, the user will rub the rice with water by hand to wash the rice more cleanly, and obviously the cleaning effect brought by the cleaning method of the current rice cooker is poor.

To solve the above defects, embodiments of present application provide a material cleaning method, a cooking appliance 10, and a readable storage medium. The main solution of the material cleaning method is as follows.

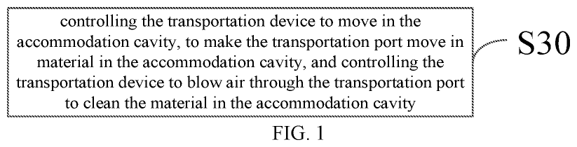

Referring to FIG. 1, in an embodiment of a material cleaning method of the present application, the material cleaning method is applied to the cooking appliance 10, the cooking appliance 10 includes an accommodation cavity 31 and a transportation device, the transportation device is provided with a transportation port. The material cleaning method includes:
S30: controlling the transportation device to move in the accommodation cavity 31, to make the transportation port move in material in the accommodation cavity 31, and controlling the transportation device to blow air through the transportation port to clean the material in the accommodation cavity 31.

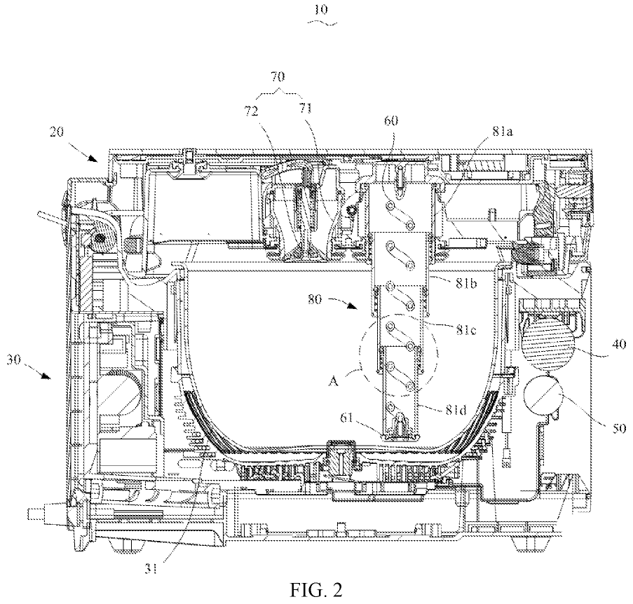

Referring to FIG. 2, in one embodiment, the cooking appliance 10 is an electric rice cooker for an example, which includes a pot body 30 and a pot lid 20, an inner pot is provided inside in the pot body 30, the inner pot forms the accommodation cavity 31, and the pot lid 20 is rotatably provided on the pot body 30. The electric rice cooker has an automatic cooking function, and also includes a material supply device 70 in communication with the accommodation cavity 31. The material supply device 70 and the transportation device can be mounted in the pot body 30 or in the pot lid 20, or defined by the pot body 30 and pot lid 20 together. The material supply device 70 is used in the rice cooker to store ingredients and input ingredients into the accommodation cavity 31. The ingredients can be various grain such as rice, wheat, millet, soybeans, bran, buckwheat, etc. In order to realize that the material supply device 70 can input ingredients into the accommodation cavity 31, in one embodiment, the material supply device 70 includes a material storage 71 and a control valve 72 that can open or close the material storage 71. The control valve 72 can be automatically controlled by an electromagnetic switch. The transportation device can input the liquid to the accommodation cavity 31, and the liquid can be water or other solvents needed in the cooking process. In one embodiment, the transportation device includes a telescopic assembly, and a pipe and a water pump 40 provided on the pipe and a water tank. The water in the water tank can flow into the accommodation cavity 31 under the drive of the water pump 40. The transportation device may also transport the air into the accommodation cavity 31. In one embodiment, the transportation device also includes an air pump 50 and an air supply pipe. As an embodiment, as shown in FIG. 2, the transportation device can share a section of the transportation pipe 60 in the pipe for transporting the liquid and the air, and the pipe connected to the air pump 50 and the water pump 40 can converge to the shared transportation pipe 60 via a solenoid valve that can control different flow paths to turn on and turn off. In such a way, the cost can be reduced and the structure is compact. Further, there is a transportation port 61 mounted at the end of the transportation pipe 60, and a spray hole is opened on the transportation port 61, and the spray hole is used as a transportation port as described above, and the air or the liquid can be sprayed from the spray hole on the transportation port 61 of the accommodation cavity 31. In other embodiment, the air pipe and the liquid pipe can also be set independently, and in the specific use process, the liquid and the air can be transported from the accommodation cavity 31 to outside by operating the air pump 50 and the water pump 40.

In the material cleaning method according to an embodiment of the present application, the material can be input into the accommodation cavity 31 by hand in advance, or can be automatically input into the accommodation cavity 31 via the cooperation of the material supply device 70 and the transportation device. In the S30, the transportation port extends into the material in the accommodation cavity 31 to move according to the preset route, or move in the up and down direction, or in the horizontal direction, or move in the horizontal direction and the up and down direction.

In the technical solution of the present application, in the material cleaning process, after the material is input into the accommodation cavity 31, the transportation device is controlled to make the transportation port extend into the material for blowing the air, then the material is fully tumbled and mixed under the drive of airflow, and in the material cleaning method of the present application, during air-blowing, the transportation port is also controlled to move in the material, so that the transportation port will not blow the air in a fixed position, the position of the transportation port will keep changing constantly, so that the material is stirred and tumbled more violently, the material in the accommodation cavity 31 can be fully stirred, to enhance the cleaning effect.

The material in the present application includes a grain and a liquid to soak the grain, the grain can be rice, wheat, millet, soybeans, wheat bran, buckwheat, etc. In one embodiment, in the S30 of the present application, the transportation port moves up and down in the liquid above the grain. In such arrangement, when the transportation pipe 60 is made of soft material, it will not be blocked by the hard material of the grain to deform the structure, when the transportation port in the liquid blows the air, due to the impact of the water flow, the liquid below the grain and the liquid can be driven to mix, to achieve the washing effect.

In another embodiment, in the S30 of the present application, the transportation port moves up and down in the grain, the transportation pipe 60 can be made of the material with a certain strength, so that it can extend into the grain. Such arrangement can make the position of the transportation port where it blows the air change in the grain all the time, to make the grain be tumbled fully during the air-blowing, thus the cleaning effect is better.

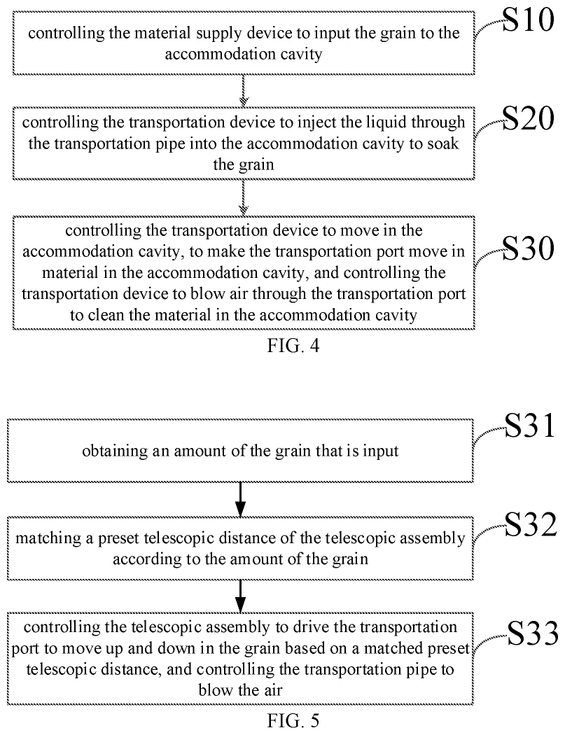

Referring to FIG. 4, in the material cleaning method of the present application, the transportation port extends into the grain for the air-blowing and a solution of automatically inputting the grain and the liquid is adopted. In an embodiment, before the S30, the material cleaning method of the present application further includes:
S10: controlling the material supply device 70 to input the grain to the accommodation cavity 31; and
S20: controlling the transportation device to inject the liquid through the transportation pipe 60 into the accommodation cavity 31 to soak the grain.

In the material cleaning method of the present application, the amount of liquid injected in the S20 is the amount of liquid that soaks the grain, which makes the cleaning of the grain more efficient and has a better cleaning effect. In order to achieve that the amount of liquid injected is the amount of liquid to soak the grain, first it can obtain the amount of the grain that is input at the material supply device 70, specifically, the weighting sensor can be set in the material supply device 70 to determine the amount of input grain by directly detecting the weight of the material reduced in the material storage 71, or the material storage 71 is set as a fixed amount of space, and the amount of the grain that is input is obtained by emptying the material storage 71 at a number of times, and then the amount of liquid required to soak the material is obtained by calculating the amount of the material, to control the operating time of the water pump 40 on the liquid pipe to inject the liquid to soak the material into the accommodation cavity 31. Of course, it is also possible to obtain the amount of the input grain directly at the accommodation cavity 31 and then perform the process of injecting liquid as described above. In such case, a sensor can be set at the accommodation cavity 31 and the amount of the grain can be measured by the grain in the accommodation cavity 31 blocking the light of the sensor.

Referring to FIG. 5, the transportation device in the present application includes a telescopic assembly 80, and a transportation pipe 60 is connected to the telescopic assembly 80, in one embodiment, the S30 includes:
S31: obtaining an amount of the grain that is input;
S32: matching a preset telescopic distance of the telescopic assembly 80 according to the amount of the grain; and
S33: controlling the telescopic assembly 80 to drive the transportation port to move up and down in the grain based on a matched preset telescopic distance, and controlling the transportation pipe 60 to blow the air.

The determination of the amount of the grain is described in the above content, which will not be repeated herein. The transportation port of the present application moves up and down in the grain. A layer of the grain is formed in a natural sinking of the grain in a stationary state before air-blowing, and all the grain can be air-blown by the transportation port moving up and down in the grain layer. The embodiment can be set up a comparison table, the amount of the grain corresponds to the telescopic distance of the telescopic assembly 80 to quickly determine the telescopic distance of the telescopic assembly 80, to achieve the purpose of quick control. The value of the telescopic distance can be converted to the height range of the material in the accommodation cavity 31 by the volume or weight of the grain, and the height range is used as the telescopic distance of the telescopic assembly 80. Since the grain after input can be sunk into the bottom of the accommodation cavity 31, the maximum length of an extension of the telescopic assembly 80 can be set in advance when it reaches the bottom of the accommodation cavity 31, when the height range of the grain in the accommodation cavity 31 is calculated, a range of the telescopic distance is from the maximum extension value of the telescopic assembly 80 to a difference between the maximum extension value and the height of the material.

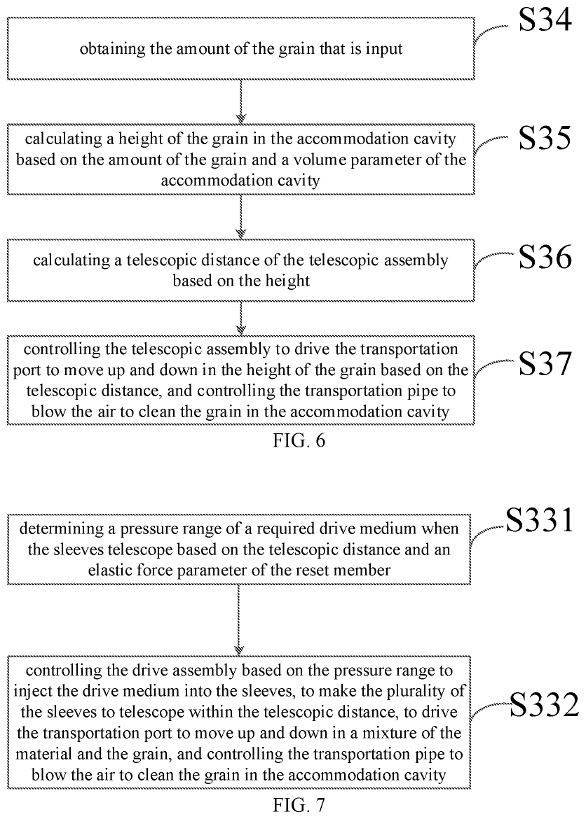

Referring to FIG. 6, in another embodiment, the S30 includes:
S34: obtaining the amount of the grain that is input;
S35: calculating a height of the grain in the accommodation cavity 31 based on the amount of the grain and a volume parameter of the accommodation cavity 31;
S36: calculating a telescopic distance of the telescopic assembly 80 based on the height; and
S37: controlling the telescopic assembly 80 to drive the transportation port to move up and down in the grain based on the telescopic distance, and controlling the transportation pipe 60 to blow the air to clean the grain in the accommodation cavity 31.

In an embodiment, the telescopic distance of the telescopic assembly 80 is determined by means of real-time calculations with specific values of the material. Such a way, compared to the way of checking the table in the above embodiment, has a higher accuracy.

Referring to FIGS. 2, 3, and 7, in one embodiment, the telescopic assembly 80 includes a plurality of sleeves (81a, 81b, 81c, 81d) sealed and nested with each other and a reset member 83 connected between two adjacent sleeves (81a, 81b, 81c, 81d), the cooking appliance 10 also includes a drive assembly in communication with the sleeves (81a, 81b, 81c, 81d) and configured for filling the sleeves with a drive medium to make the plurality of the sleeves (81a, 81b, 81c, 81d) to telescope, the S33 includes:
S331: determining a pressure range of a required drive medium when the sleeves (81a, 81b, 81c, 81d) telescope based on the telescopic distance and an elastic force parameter of the reset member 83; and
S332: controlling the drive assembly based on the pressure range to inject the drive medium into the sleeves (81a, 81b, 81c, 81d), to make the plurality of the sleeves (81a, 81b, 81c, 81d) to telescope within the telescopic distance, to drive the transportation port to move up and down in a mixture of the material and the grain, and controlling the transportation pipe 60 to blow the air to clean the grain in the accommodation cavity.

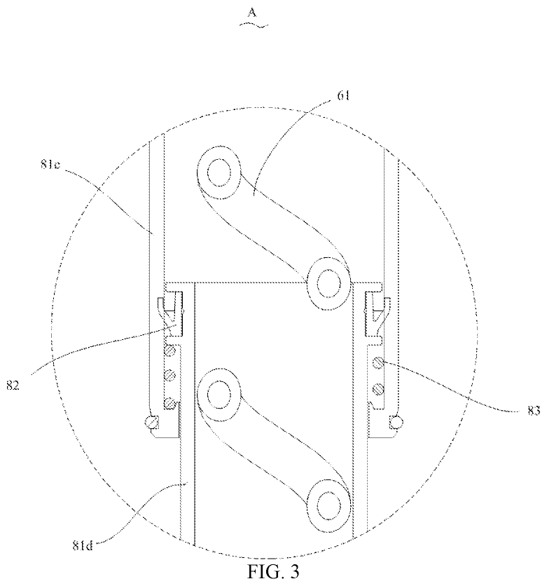

In an embodiment, the telescopic assembly 80 is formed by a plurality of sleeves, and the telescopic assembly 80 shown in FIG. 3 includes four sleeves (81a, 81b, 81c, 81d) from top to bottom, an upper end of the uppermost sleeve is closed and a lower end of the lowermost sleeve is closed, a seal ring 82 is mounted between two adjacent sleeves (81b, 81c), and the sleeves (81a, 81b, 81c, 81d) can slide relative to the seal ring 82, so that the interior of the plurality of sleeves (81a, 81b, 81c, 81d) forms a sealed cavity, and an air path is driven to be in communication with the upper end of the upper sleeves, so that the drive medium can be filled into the sleeves, and a reset member 83 is clamped between the two adjacent sleeves, the reset member 83 can be a spring, a shrapnel or other elastic structure. The drive assembly is formed by the pipe and the drive member. When the sleeves are driven by pneumatic means to extend out in the present application, and the preferred way is to share an air pump 50 with the transportation device to reduce costs, but of course, the drive assembly can also be provided separately with another air pump 50 for precise control. When the drive medium is liquid, the drive member can be a water pump 40, the water pump 40 can also be shared by above transportation device, or the water pump 40 can be shared separately. In the actual driving process, an extension length of the sleeves in the telescopic assembly 80 is mainly controlled by the pressure of the drive medium, specifically, a product of the pressure of the drive medium and the sleeve is the driving force, and when the driving force is balanced with the elastic force of the reset member 83, the sleeves stops telescoping, that is, when it is needed to control the sleeves (81a, 81b, 81c, 81d) to telescope up and down to drive the transportation port to move up and down for air-blowing, the elastic force parameter curve of the reset member 83 being compressed or stretched to different lengths in the process of the sleeves (81a, 81b, 81c, 81d) extending out is taken as a known amount, and combined with the telescopic distance to calculate a pressure range of the required drive medium, and the drive assembly is then controlled to inject the drive medium of the pressure range into the sleeves, and when the injected drive medium changes in this pressure range, the expansion and contraction of the telescopic assembly 80 is achieved. This way that the plurality of sleeves (81a, 81b, 81c, 81d) are driven by the drive medium to telescope, makes telescoping control process more sensitive, and the plurality of sleeves after contraction occupy less space. It can be understood that in the material cleaning method of the present application, the telescopic assembly 80 in addition to the above the structure of the sleeve, but also can be, for example, screw mechanism, linkage mechanism, etc.

In an embodiment, the controlling the transportation pipe 60 to blow the air in S30 includes:
obtaining an amount of the grain that is input;
matching a preset air-blowing frequency of the transportation pipe 60 according to the amount of the grain; and
controlling the transportation pipe 60 to blow the air based on a matched air-blowing frequency; or
obtaining an amount of the material input;
calculating an air-blowing frequency of the transportation pipe 60 based on the amount of the material and a volume parameter of the accommodation cavity 31; and
controlling the transportation pipe 60 to blow the air according to the calculated air-blowing frequency.

In an embodiment, by table search or real-time calculation, the air-blowing frequency increases when the amount of the material is larger, and the air-blowing frequency decreases when the amount of the material is smaller, that is, the air-blowing frequency can be a positive relationship with the amount of the material, such arrangement brings the advantages that it can speed up the rate of mixing and tumbling of the material and water in the case of more material, to shorten the cleaning time and improve the cleaning effect.

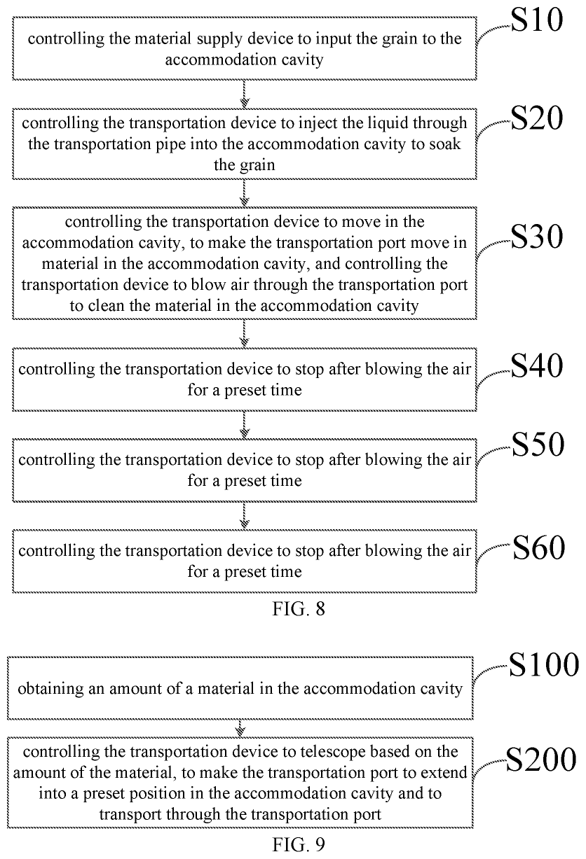

Referring to FIG. 8, in an embodiment, the material cleaning method of the present application also includes:
S40: controlling the transportation device to stop after blowing the air for a preset time;
S50: controlling the transportation device to drive the transportation port to move to a bottom of the grain; and
S60: controlling the transportation device to suck up through the transportation port to drain the liquid out of the accommodation cavity 31.

After the cleaning is completed, the water pump 40 in the transportation device reverses to pump the liquid in the accommodation cavity 31 to drain the liquid with impurities after cleaning, to keep the grain clean and improve the cooking effect of the subsequent ingredients.

Referring to FIG. 2, the embodiments of the present application provide a cooking appliance 10, which includes a controller, an accommodation cavity 31 and a transportation device with a transportation port, the controller is configured for:
controlling the transportation device to move in the accommodation cavity 31, to make the transportation port move in the material in the accommodation cavity 31, and controlling the transportation device to blow the air through the transportation port to clean the material in the accommodation cavity 31.

The material cleaning method of the embodiment of the present application can be applied to the cooking appliance 10. It should be noted that the above explanatory description of the implementation and beneficial effects of the material cleaning method is also applied to the cooking appliance 10 of the present implementation, which will not be expanded in detail herein to avoid redundancy.

In an embodiment, the cooking appliance 10 further includes a material supply device 70, the controller is further configured for:
controlling the material supply device to supply the grain into the accommodation cavity 31, and controlling the transportation device to inject the liquid to soak the grain into accommodation cavity 31.

In an embodiment, the controller is configured for:
obtaining an amount of the grain that is input, matching a preset telescopic distance of the telescopic assembly 80 according to the amount of the grain, controlling the telescopic assembly 80 to drive the transportation port to move up and down in the grain based on a matched preset telescopic distance, and controlling the transportation pipe to blow the air to clean the grain in the accommodation cavity 31; or
obtaining the amount of the grain that is input, calculating a height of the grain in the accommodation cavity 31 based on the amount of the grain and a volume parameter of the accommodation cavity, calculating a telescopic distance of the telescopic assembly based on the height, controlling the telescopic assembly 80 to drive the transportation port to move up and down in the grain based on the telescopic distance, and controlling the transportation pipe to blow the air to clean the grain in the accommodation cavity.

In one embodiment, the telescopic assembly 80 includes a plurality of sleeves sealed and nested with each other, and a reset member 83 connected between two adjacent sleeves; the cooking appliance 10 further includes a drive assembly in communication with the sleeves, the controller is configured for determining a pressure range of a required drive medium when the sleeves telescope based on the telescopic distance and an elastic force parameter of the reset member; and controlling the drive assembly based on the pressure range to inject the drive medium into the sleeves, to make the plurality of the sleeves to telescope within the telescopic distance, to drive the transportation port to move up and down in the grain, and controlling the transportation pipe to blow the air to clean the grain in the accommodation cavity.

In an embodiment, the controller is configured for:
obtaining an amount of the grain that is input, matching a preset air-blowing frequency of the transportation device according to the amount of the grain; and controlling the transportation device to blow air based on a matched air-blowing frequency; or
obtaining an amount of the material input, calculating an air-blowing frequency of the transportation device based on the amount of material and a volume parameter of the accommodation cavity; and controlling the transportation device to blow air according to the calculated air-blowing frequency.

In an embodiment, the controller is configured for:
controlling the transportation device 60 to stop after blowing the air for a preset time;
controlling the transportation device to drive the transportation port to move to a bottom of the grain; and
controlling the transportation device 60 to suck up through the transportation port to drain the liquid out of the accommodation cavity 31.

Referring to FIG. 9, in an embodiment of the material cleaning method of the present application, the material cleaning method is applied to a cooking appliance 10, the cooking appliance 10 includes an accommodation cavity 31, a transportation device in communication with the accommodation cavity 31, the transportation device is provided with a transportation port 61, the material cleaning method includes:
S100: obtaining an amount of a material in the accommodation cavity 31; and
S200: controlling the transportation device to telescope based on the amount of the material, to make the transportation port 61 to extend into a preset position in the accommodation cavity 31 and to transport through the transportation port 31.

Referring to FIG. 2, in one embodiment, the cooking appliance 10, for example, a rice cooker, includes a pot body 30 and a pot lid 20, an inner pot is provided in the pot body 30, the inner pot forms the accommodation cavity 31, the pot lid 20 is rotatably provided on the pot body 30, the rice cooker has an automatic cooking function and also includes a transportation device and a material supply device 70 in communication with the accommodation cavity 31, the transportation device and the material supply device 70 can be mounted in the pot body 30, or in the pot lid 20, or defined by the pot body 30 and pot lid 20 together.

The material in the present application includes the grain and the liquid to soak the grain, and in the S100, the grain and the liquid can be added manually in advance to the accommodation cavity 31, or the cooking appliance 10 can add the material automatically. In an embodiment, the present application can store the ingredients in the rice cooker through the material supply device 70. The ingredients can be, for example various grain, beans, buckwheat, etc., the ingredients are input into the accommodation cavity 31 under program control when automatic rice cooking. In order to realize that the material supply device 70 can input the ingredients into the accommodation cavity 31. In one embodiment, the material supply device 70 includes a grain storage 71 and a control valve 72 that can open or close the grain storage 71, where the control valve 72 can be automatically controlled by an electromagnetic switch. After the grain ingredients are input into the material supply device 70, the liquid can be injected into the accommodation cavity 31 manually, or the liquid can be injected into the accommodation cavity 31 automatically by the device. The transportation device of the present application has a liquid pipe and an air pipe. In one embodiment, the liquid pipe includes a pipe, and a water pump 40 and a water tank set on the pipe. Under the drive of the water pump 40, the water in the water tank can flow into the accommodation cavity 31. In other embodiments, the liquid pipe can also be directly connected to an external water source via a pipe with a control switch, such as a tap water pipe. The air pipe is used to transport the air into the accommodation cavity 31. In one embodiment, the air pipe consists of the air pump 50 and the pipe in communication with the air pump 50. As an embodiment, as shown in FIG. 2, the ends of the air pipe and the liquid pipe connected to the accommodation cavity 31 can share a section of the transportation pipe 60, and the air pipe and the liquid pipe can converge to the shared section of the transportation pipe 60 via a magnetic valve that can control different flow paths. In this way, the cost can be reduced and the structure is more compact. Furthermore, there is a transportation port 61 mounted at the end of the transportation port 60, and a spray hole is opened on the transportation port 61, and the spray hole can be used as a transportation port 61 or a liquid outlet, and the air or liquid can be sprayed from the spray hole on the transportation port 61 the accommodation cavity 31. In other embodiments, the air pipe and the liquid pipe may also be set independently. In an embodiment, in the material cleaning method of the present application, before the S100, the present application may control the transportation device to automatically inject the liquid that soaks the grain into the accommodation cavity 31 after the material supply device 70 is controlled to input the grain into the accommodation cavity.

Further, in the S100 of the present application, when the amount of the material is obtained, preferably the amount of the grain is obtained, such as the volume or the weight of the grain, and since the material cleaning method of the present application ultimately is required to determine the position of the transportation port 61 on the transportation device extending into the accommodation cavity 31, thus the amount of the grain obtained will eventually be converted to volume. In some embodiments, the amount of the grain can be obtained by first obtaining the amount of the grain that is input at the material supply device 70, specifically, the weighting sensor can be set in the material supply device 70 to determine the amount of input grain by directly detecting the weight of the grain reduced in the grain storage 71, or the grain storage 71 is set as a fixed amount of space, and the amount of the grain that is input is obtained by emptying the grain storage 71 at a number of times. Of course, it is also possible to obtain directly the amount of the input grain in the accommodation cavity 31, and a sensor for detecting the accommodation cavity 31 can be set to detect the amount of the grain that is input to the accommodation cavity 31, for example, the amount of the grain can be measured by the grain in the accommodation cavity 31 blocking the light of the sensor.

In the technical solution of the present application, during the operation of the cooking appliance, the transportation device is controlled to telescope based on the amount of the material in the accommodation cavity 31, to make the transportation port extend into a preset position in the accommodation cavity 31, so that, for example, during the material cleaning process of the cooking appliance, the transportation port 61 of the transportation device can better transport the air to the material, to achieve the full tumbling and mixing effect of the material, or in the cleaning process, the transportation port 61 can better transport water to the outside of the accommodation cavity, to enhance the cleaning effect.

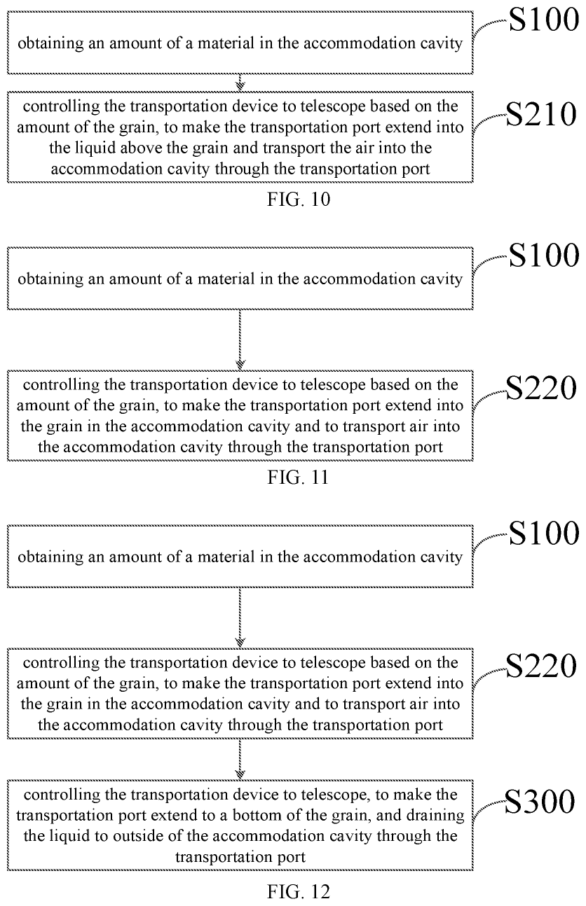

Referring to FIG. 10, the material cleaning method of the present application is applied in some application scenarios, the S200 can includes:
S210: controlling the transportation device to telescope based on the amount of the grain, to make the transportation port 61 extend into the liquid above the grain and transport the air into the accommodation cavity 31 through the transportation port 61.

In an embodiment, the material cleaning method is particularly suitable for the cleaning process of the grain, first the telescopic distance of the transportation device can be determined by the amount of the grain that is input, so that the transportation port 61 can extend into the liquid above the grain, and the air is blown to the liquid by the air pipe in the transportation device, so that the grain and the liquid can be fully mixed, so that the grain are cleaned well.

Referring to FIG. 11, in another embodiment, in the material cleaning method of the present application, the S200 can includes:
S220: controlling the transportation device to telescope based on the amount of the grain, to make the transportation port 61 extend into the grain in the accommodation cavity 31 and to transport air into the accommodation cavity 31 through the transportation port 61. The embodiment is also particularly suitable for use in the cleaning operation of the material during the cooking process of the cooking appliance, and the embodiment differs from the previous embodiment in that the transportation port 61 extends into the grain for the air transportation, which has the advantage that, compared to the previous embodiment, the tumbling and mixing of the grain and the liquid is better when the amount of the grain that is input into the grain is larger, because the transportation port 61 extends into the grain, it can better cause the grain at the bottom also to tumble and mix, so that the cleaning effect is better.

In order to further enhance the cleaning effect, the present application, in the S220, can make the transportation port 61 extend into a middle of the height of the grain, then in the air-blowing process of the transportation port 61, it can more evenly promote the grain for tumbling and mixing, especially when the amount of input grain is larger, the mixing and stirring effect of the grain at the bottom is also better, the effect of hand kneading is fully simulated, so the cleaning effect is good.

Referring to FIGS. 2 and 3, in an embodiment of the present application, the transportation device further includes a telescopic assembly and a transportation pipe provided on the telescopic assembly, in the S200: the controlling the transportation device to telescope according to the amount of material, to make the transportation port 61 extend into a preset position in the accommodation cavity 31 includes:
matching a preset telescopic distance of the telescopic assembly 80 according to the amount of the material;
controlling the telescopic assembly 80 to telescope based on a matched preset telescopic distance, to make the transportation port 61 extend into the preset position in the accommodation cavity 31; or
calculating a telescopic distance of the telescopic assembly 80 based on the amount of the material and a volume parameter of the accommodation cavity 31; and
controlling the telescopic assembly 80 to telescope based on the telescopic distance, to make the transportation port 61 extend into the preset position in the accommodation cavity 31.

In an embodiment, the telescopic assembly 80 includes a plurality of sleeves (81a, 81b, 81c, 81d) sealed and nested with each other and a reset member 83 connected between two adjacent sleeves, the cooking appliance 10 further includes a drive device connected to the sleeves (81a, 81b, 81c, 81d) and configured for filling the sleeves with a drive medium, the telescoping control process of the telescopic assembly 80:
determining a pressure of the drive medium required to drive the sleeves to extend out based on a correspondence relationship of the telescopic distance and an elastic force parameter of the reset member 83; and
controlling a drive pipe based on the pressure to inject the drive medium into the sleeves, to make the plurality of the sleeves extend out, to make the transportation port 61 on the air pipe reach at a middle position and blow the air.

In an embodiment, the telescopic assembly 80 is formed a plurality of sleeves, the telescopic assembly 80 shown in FIG. 3 includes four sleeves (81a, 81b, 81c, 81d) from top to bottom, it can be understood that in other embodiments, the telescopic assembly 80 can be in other structural forms, such as rod structure, screw structure, etc., in addition to the above sleeve structure. In an embodiment, the upper end of the uppermost sleeve 81a is closed and the lower end of the lowermost sleeve 81d is closed, a seal ring 82 is mounted between two adjacent sleeves (81b, 81c), and the sleeves can slide relative to the seal ring 82, so that the interior of the plurality of sleeves forms a sealed cavity, and the air path is driven to be in communication with the upper end of the upper sleeve 81a, so that the drive medium can be filled into the interior of the sleeves. A reset member 83 is clamped between the adjacent sleeves, a reset member 83 can be a spring, shrapnel or other elastic structure, the drive pipe consists of the pipe and drive member. The drive pipe is formed by the pipe and the drive member. When the present application uses air as the drive medium to drive the sleeves to extend out, the drive member can be an air pump 50, and the preferred way is that the drive pipe and the air pipe share the same air pump 50 to reduce costs, and the drive pipe and the air pipe can be controlled to turn on and turn off by a magnetic valve. Of course, the drive pipe can be provided with another air pump 50 alone to accurately control respectively. When the drive medium is liquid, the drive member can be a water pump, and the water pump 40 can be shared by the liquid pipe, and the water pump 40 can be provided alone. In the actual driving process, an extension length of the sleeves in the telescopic assembly 80 is mainly controlled by the pressure of the drive medium, specifically a product of the pressure of the drive medium and the area of the sleeve is the driving force, and when the driving force is balanced with the elastic force of the reset member 83, the sleeves stop telescoping, i.e., when it is needed to control the sleeves to extend out a certain distance, so that the telescopic assembly 80 can drive the transportation port 61 of the air pipe to the middle position, the elastic force parameter curve of the reset member being compressed to the different lengths in the process of the sleeves extending out is taken as a well known telescopic distance to calculate the pressure of the required drive medium, then the drive pipe is controlled to inject the drive medium of the pressure into the sleeves. The embodiment can preset the comparison table, and the telescopic distance corresponds to one pressure value of the comparison table, the pressure of the drive medium required to be injected into the drive pipe is determined quickly by the table search, such way make the response in the control process more quickly.

In another embodiment, the telescopic control process of the above telescopic assembly 80 can also include:
calculating a pressure of the drive medium required to drive the sleeves to extend out based on the telescopic distance and the elastic force parameter of the reset member 30; and
controlling the drive pipe to inject the drive medium into the sleeves based on the pressure, to make the transportation port 61 of the air pipe reach at the middle position and the blow air.

The embodiment differs from the previous embodiment in that the pressure of the drive medium injected by the drive pipe is obtained by real time calculation, which is more accurate compared to the table search method of the previous embodiment.

Referring to FIG. 12, in an embodiment, after the S220, the material cleaning method of the present application further includes:
S300: controlling the transportation device to telescope, to make the transportation port 61 extend to a bottom of the grain, and draining the liquid to outside of the accommodation cavity 31 through the transportation port 61.

The material cleaning method of the present application is suitable for application on the material cleaning operation in the cooking process of the cooking appliance.

After the cleaning is completed, then the water pump 40 in the liquid pipe of the transportation device is controlled to turn over to pump the liquid in the accommodation cavity 31 to drain the liquid with impurities out after cleaning, to keep the grain clean and enhance the cooking effect of the ingredients.

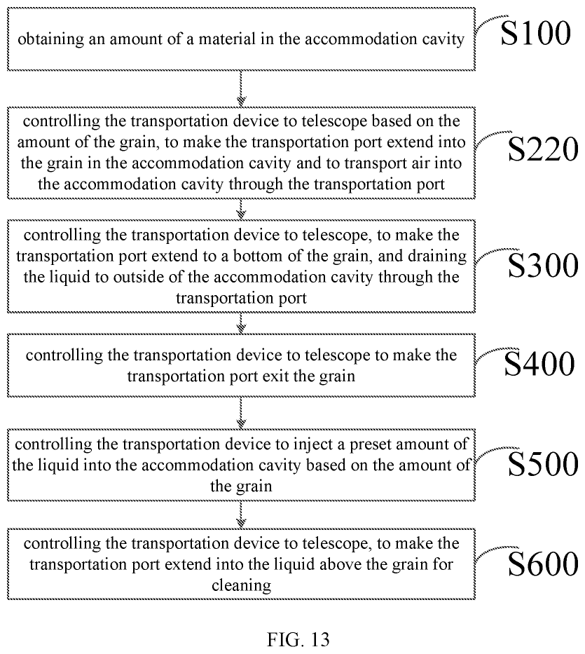

Referring to FIG. 13, in an embodiment, after the S300, the method includes:
S400: controlling the transportation device to telescope to make the transportation port 61 exit the grain;
S500: controlling the transportation device to inject a preset amount of the liquid into the accommodation cavity 31 based on the amount of the grain; and
S600: controlling the transportation device to telescope, to make the transportation port extend into the liquid above the grain for cleaning.

The material cleaning method of the present application, after the material cleaning is completed, also controls the telescopic assembly in the transportation device to telescope, to clean the transportation port 61, which can avoid the grain from adhering to the transportation port 61, and the liquid injected in the S500 is the water needed for the cooking heating and boiling process, and the transportation device is controlled to telescope, to exit the grain and then the water is added again, which can avoid the grain from being impacted to form a pit when the boiling water is transported, or avoid the grain from being accumulated around the transportation port 61, so that the grain can be heated more evenly.

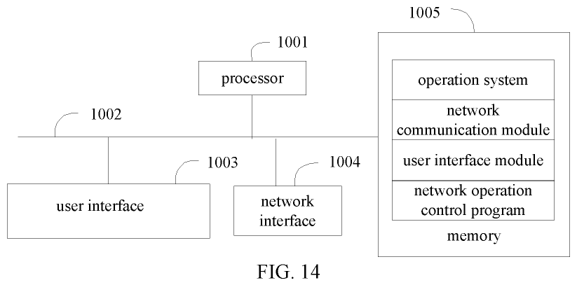

As shown in FIG. 14, FIG. 14 is a schematic structural view of the terminal of the hardware operating environment involved in an embodiment of the present application.

The terminal of the embodiments of the present application can be various cooking appliances 10, where the cooking appliances 10 can be electric rice cookers, electric pressure cookers, electric stew pots, health kettles products, which are not limited to household environments or commercial appliances.

As shown in FIG. 14, the terminal may include: a processor 1001, such as a CPU, a network interface 1004, a user interface 1003, a memory 1005, and a communication bus 1002. The communication bus 1002 is used to enable communication connections among these components. The user interface 1003 can include a display, an input unit such as keyboard, etc. The user interface 1003 optionally can also include a standard wired interface, a wireless interface. The network interface 1004 can include a standard wired interface, a wireless interface (such as WI-FI interface). The memory 1005 can be a high-speed random access memory (RAM), or a stable memory (non-volatile memory), such as a disk memory. The memory 1005 may also be a storage device independent of the aforementioned processor 1001.

As shown in FIG. 14, the memory 1005 as a computer readable storage medium may include an operating system, a network communication module, a user interface module, and a control program for the cooking appliance or a control program for the terminal.

In the terminal shown in FIG. 14, the network interface 1004 is mainly used to connect to the background server and communicate with the background server for data; the processor 1001 can be used to call the control program of the cooking appliance stored in the memory 1005 and perform the material cleaning method described above.

The specific embodiment of the computer-readable storage medium of the present application is basically the same as each of the above embodiments of the material cleaning method, and will not be repeated here.

It should be noted that herein the term “includes”, “comprises” or any other variation thereof is intended to cover non-exclusive inclusion, so that a process, method, article or system that includes a set of elements includes not only those elements, but also other elements that are not explicitly listed, or that are inherent to such process, method, article, or system. Without further limitation, an element defined by the statement “including a” does not preclude the existence of another identical element in the process, method, article, or system that includes that element.

The above numerical designation of the embodiments of the present application is for descriptive purposes only and does not represent the merits of the embodiments.

From the above description of the embodiments, it is clear to those skilled in the art that the method of the above embodiments can be implemented with the help of software plus the needed common hardware platform, or of course with hardware, but in many cases the former is the better way of implementation. Based on this understanding, the technical solution of the present application, in essence, or the part that contributes to the prior art, may be embodied in the form of a software product, which is stored in a storage medium (e.g., ROM/RAM, disk, CD-ROM) as described above, including a number of instructions to enable a terminal device (which may be a cell phone, a computer, a server, a rice cooker, or a network device etc.) to perform the method described in various embodiments of the present application.

The above is only an embodiment of the present application and is not intended to limit the scope of the present application. Any equivalent structure or equivalent process transformation using the contents of the specification and the accompanying drawings of the present application, or any direct or indirect application in other related technical fields, all fall within the scope of the present application.

1.-18. (canceled)

19. A material cleaning method comprising:
controlling a transportation device of a cooking appliance to move in an accommodation cavity of the cooking appliance, to make a transportation port of the transportation device move in material in the accommodation cavity; and
controlling the transportation device to blow air through the transportation port to clean the material in the accommodation cavity.

20. The material cleaning method according to claim 19, wherein:
the material includes a grain and a liquid soaking the grain; and
in a process of controlling the transportation device to move in the accommodation cavity, to make the transportation port move in the material in the accommodation cavity, and controlling the transportation device to blow the air through the transportation port to clean the material in the accommodation cavity, the transportation port moves up and down in the liquid above the grain.

21. The material cleaning method according to claim 19, wherein:
the material includes a grain and a liquid soaking the grain; and
in a process of controlling the transportation device to move in the accommodation cavity, to make the transportation port move in the material in the accommodation cavity, and controlling the transportation device to blow the air through the transportation port to clean the material in the accommodation cavity, the transportation port moves up and down in the grain.

22. The material cleaning method according to claim 21,
wherein the cooking appliance further includes a material supply device;
the method further comprising, before controlling the transportation device to move in the accommodation cavity, to make the transportation port move in the material in the accommodation cavity, and controlling the transportation device to blow the air through the transportation port to clean the material in the accommodation cavity:
controlling the material supply device to input the grain to the accommodation cavity; and
controlling the transportation device to inject the liquid into the accommodation cavity to soak the grain.

23. The material cleaning method according to claim 22, wherein
the transportation device includes a telescopic assembly and a transportation pipe connected to the telescopic assembly, and the transportation pipe is provided with the transportation port; and
controlling the transportation device to move in the accommodation cavity, to make the transportation port move in the material in the accommodation cavity, and controlling the transportation device to blow the air through the transportation port to clean the material in the accommodation cavity includes:
obtaining an amount of the grain; and
controlling the telescopic assembly and the transportation pipe according to at least the amount of the grain, including:
matching a preset telescopic distance of the telescopic assembly according to the amount of the grain, and controlling the telescopic assembly to drive the transportation port to move up and down in the grain based on a matched preset telescopic distance, and controlling the transportation pipe to blow the air to clean the grain in the accommodation cavity; or
calculating a height of the grain in the accommodation cavity based on the amount of the grain and a volume parameter of the accommodation cavity, calculating a telescopic distance of the telescopic assembly based on the height, and controlling the telescopic assembly to drive the transportation port to move up and down in the grain based on the telescopic distance, and controlling the transportation pipe to blow the air to clean the grain in the accommodation cavity.

24. The material cleaning method according to claim 23, wherein:
the telescopic assembly includes a plurality of sleeves sealed and nested with each other, and a reset member connected between two adjacent ones of the plurality of sleeves;
the cooking appliance further includes a drive assembly in communication with the sleeves and configured to fill the sleeves with a drive medium to cause the plurality of sleeves to telescope; and
controlling the telescopic assembly to drive the transportation port to move up and down in the grain based on the telescopic distance, and controlling the transportation pipe to blow the air to clean the grain in the accommodation cavity includes:
determining a pressure range needed for the drive medium when the sleeves telescope based on the telescopic distance and an elastic force parameter of the reset member; and
controlling the drive assembly based on the pressure range to inject the drive medium into the sleeves, to cause the plurality of the sleeves to telescope within the telescopic distance, to drive the transportation port to move up and down in the grain, and controlling the transportation pipe to blow the air to clean the grain in the accommodation cavity.

25. The material cleaning method according to claim 21, wherein controlling the transportation pipe to blow the air to clean the grain in the accommodation cavity includes:
obtaining an amount of the grain; and
controlling the transportation pipe according to at least the amount of the material input, including:
matching a preset air-blowing frequency of the transportation device according to the amount of the grain, and controlling the transportation device to blow the air based on a matched air-blowing frequency; or
calculating an air-blowing frequency of the transportation device based on the amount of the grain and a volume parameter of the accommodation cavity, and controlling the transportation device to blow the air according to the calculated air-blowing frequency.

26. The material cleaning method according to claim 21, further comprising, after controlling the transportation device to blow the air through the transportation port:
controlling the transportation device to stop after blowing the air for a preset time;
controlling the transportation device to drive the transportation port to move to a bottom of the grain; and
controlling the transportation device to suck up through the transportation port to drain the liquid out of the accommodation cavity.

27. A material cleaning method comprising:
obtaining an amount of material in an accommodation cavity of a cooking appliance; and
controlling a transportation device of the cooking appliance to telescope based on the amount of the material, to make the transportation port extend into a preset position in the accommodation cavity, and to transport through a transportation port of the transportation device, the transportation device being in communication with the accommodation cavity.

28. The material cleaning method according to claim 27, wherein:
the material includes a grain and a liquid soaking the grain; and
controlling the transportation device to telescope based on the amount of the material, to make the transportation port extend into the preset position in the accommodation cavity, and to transport through the transportation port includes:
controlling the transportation device to telescope based on the amount of the grain, to make the transportation port extend into the liquid above the grain, and to transport air into the accommodation cavity through the transportation port.

29. The material cleaning method according to claim 27, wherein:
the material includes grain and a liquid soaking the grain; and
controlling the transportation device to telescope based on the amount of the material, to make the transportation port extend into the preset position in the accommodation cavity, and to transport through the transportation port includes:
controlling the transportation device to telescope based on the amount of the grain, to make the transportation port extend into the grain in the accommodation cavity, and to transport air into the accommodation cavity through the transportation port.

30. The material cleaning method according to claim 29, wherein in a process of controlling the transportation device to telescope based on the amount of the grain, to make the transportation port extend into the grain in the accommodation cavity:
the transportation port extends to a middle position of a height of the grain.

31. The material cleaning method according to claim 29, further comprising, after controlling the transportation device to telescope based on the amount of the grain, to make the transportation port extend into the grain in the accommodation cavity, and to transport the air into the accommodation cavity through the transportation port:
controlling the transportation device to telescope, to make the transportation port extend into a bottom of the grain, and to drain the liquid out from the accommodation cavity through the transportation port.

32. The material cleaning method according to claim 31, further comprising, after controlling the transportation device to telescope, to make the transportation port extend into the bottom of the grain, and to drain the liquid out from the accommodation cavity through the transportation port:
controlling the transportation device to telescope, to make the transportation port exit the grain;
controlling the transportation device to inject a preset amount of the liquid into the accommodation cavity based on the amount of the grain; and
controlling the transportation device to telescope, to make the transportation port extend into the liquid above the grain for cleaning.

33. The material cleaning method according to claim 27, wherein:
the transportation device includes a telescopic assembly and a transportation pipe provided in the telescopic assembly, and the transportation pipe is provided with the transportation port; and
controlling the transportation device to telescope based on the amount of the material, to make the transportation port extend into the preset position in the accommodation cavity includes:
matching a preset telescopic distance of the telescopic assembly according to the amount of the material, and controlling the telescopic assembly to telescope based on a matched preset telescopic distance, to make the transportation port extend into the preset position in the accommodation cavity; or
calculating a telescopic distance of the telescopic assembly based on the amount of the material and a volume parameter of the accommodation cavity, and controlling the telescopic assembly to telescope based on the telescopic distance, to make the transportation port extend into the preset position in the accommodation cavity.

34. The material cleaning method according to claim 33, wherein:
the cooking appliance further includes a drive device, the telescopic assembly includes a plurality of sleeves sealed and nested with each other and a reset member connected between two adjacent ones of the sleeves, and the drive device is configured to inject a drive medium into the sleeves; and
controlling the telescopic assembly to telescope based on the matched preset telescopic distance, to make the transportation port extend into the preset position in the accommodation cavity includes:
determining a pressure of the drive medium required to drive the sleeves to extend out based on a correspondence relationship of the matched preset telescopic distance and an elastic force parameter of the reset member; and
controlling the drive device to inject the drive medium of the pressure into the sleeves, to make the plurality of the sleeves to telescope, to make the transportation port extend into the preset position in the accommodation cavity.

35. The material cleaning method according to claim 33, wherein:
the cooking appliance further includes a drive device, the telescopic assembly includes a plurality of sleeves sealed and nested with each other and a reset member connected between two adjacent ones of the sleeves, and the drive device is configured to inject a drive medium into the sleeves; and
controlling the telescopic assembly to telescope based on the telescopic distance, to make the transportation port extend into the preset position in the accommodation cavity includes:
calculating a pressure of the drive medium required to drive the sleeves to extend out based on the telescopic distance and the elastic force parameter of the reset member; and
controlling the drive device to inject the drive medium of the pressure into the sleeves, to make the plurality of the sleeves to telescope, to make the transportation port extend into the preset position in the accommodation cavity.

36. A cooking appliance comprising:
an accommodation cavity;
a transportation device in communication with the accommodation cavity, the transportation device being provided with a transportation port; and
a controller configured to:
control the transportation device to move in the accommodation cavity, to make the transportation port move in material in the accommodation cavity; and
controlling the transportation device to blow air through the transportation port to clean the material in the accommodation cavity.

37. The cooking appliance according to claim 36, wherein:
the material includes a grain and a liquid soaking the grain; and
in a process of controlling the transportation device to move in the accommodation cavity, to make the transportation port move in the material in the accommodation cavity, and controlling the transportation device to blow the air through the transportation port to clean the material in the accommodation cavity, the transportation port moves up and down in the liquid above the grain.

38. A non-transitory computer-readable storage medium storing a control program of a cooking appliance that, when executed by a processor, causes the processor to perform the material cleaning method according to claim 19.
